(19) United States
(12) Patent Application Publication
(10) Pub. No.: US 2024/0352986 A1
(43) Pub. Date: Oct. 24, 2024

(54) BRAKE DEVICE

(71) Applicant: HYUNDAI MOBIS CO., LTD., Seoul (KR)

(72) Inventor: Bo Ram YOON, Yongin-si (KR)

(73) Assignee: HYUNDAI MOBIS CO., LTD., Seoul (KR)

(21) Appl. No.: 18/487,766

(22) Filed: Oct. 16, 2023

(30) Foreign Application Priority Data
Apr. 19, 2023 (KR) 10-2023-0051189

(51) Int. Cl. F16D 65/18

(52) U.S. Cl. CPC F16D 65/18; F16D 2121/24; F16D 2125/40

(57) ABSTRACT

Disclosed is a brake device including a brake pad, a pad pusher connected to the brake pad to linearly move the brake pad, a caliper body having a cylinder space defined therein where the pad pusher is seated, and a pad carrier that guides protrusions on both side surfaces of the brake pad, wherein the pad carrier is connected to the caliper body, wherein the pad pusher includes a bolt screw that rotates with respect to an axis within the cylinder space, a movable nut connected to the bolt screw, and a piston connected to one end of the movable nut, wherein the movable nut moves along a direction of the cylinder space by the rotation of the bolt screw, wherein the piston has a cylindrical shape with a front surface and a rear surface open, and further includes a piston cover closing the front surface.

### CROSS-REFERENCE TO RELATED APPLICATIONS

Pursuant to 35 U.S.C. § 119(a), this application claims the benefit of Korean Patent Application No. 10-2023-0051189, filed on Apr. 19, 2023, which is hereby incorporated by reference as if fully set forth herein.

### TECHNICAL FIELD

The present embodiments relate to a brake device applicable to vehicles in all fields, and more specifically, to a brake device connected to a brake disc of a vehicle.

### BACKGROUND

A brake device mounted on a vehicle is a device for decelerating or stopping the vehicle while driving, or maintaining a stopped state of the vehicle, and brakes the vehicle by strongly pressing a disc-shaped brake disc that rotates along with a wheel of the vehicle with brake pads from both sides.

Recently, there are two types of brake devices: a hydraulic brake and an electro mechanical brake (EMB). The hydraulic brake uses a hydraulic pressure to push a brake pad. In the EMB, an actuator pushes the brake pad with power from a motor.

The EMB further includes components not used in the hydraulic brake, such as the motor, the actuator, a ball screw, a bearing, and the like. Among such components, the piston, the ball screw, the bearing, and the like, which are components that receive the power of the motor, must be seated within a caliper body, and become a factor that increases a length of a cylinder space defined in the caliper body. However, as the length of the cylinder space increases, it is more disadvantageous for a layout within the caliper body and a volume of the caliper body increases, causing an increase in manufacturing costs.

In addition, in the conventional EMB, a structure to prevent rotation of a ball screw nut during a linear movement was applied into the cylinder space of the caliper body. The rotation-preventing structure applied into the cylinder space also became the factor that increases the length of the cylinder space, which affected the increase in the cost.

Therefore, there is a need for technology that solves the above-mentioned problems.

### SUMMARY

Embodiments of the present disclosure are to provide a brake device that solves the problems described above.

Specifically, embodiments of the present disclosure are to provide a brake device with an improved layout of a caliper body.

Additionally, embodiments of the present disclosure are to provide a brake device that reduces a volume of a caliper body.

Additionally, embodiments of the present disclosure are to provide a brake device with reduced drag characteristics of a piston.

Additionally, embodiments of the present disclosure are to provide a brake device with reduced weight and cost.

Problems to be solved in the present disclosure are not limited to the problems mentioned above, and other problems not mentioned will be clearly understood by those skilled in the art in the technical field to which the present disclosure belongs from the description below.

A brake device for achieving the above-described purposes includes a brake pad, a pad pusher connected to the brake pad to linearly move the brake pad, a caliper body having a cylinder space defined therein where the pad pusher is seated, and a pad carrier that guides protrusions on both side surfaces of the brake pad, wherein the pad carrier is connected to the caliper body, the pad pusher includes a bolt screw that rotates around an axis within the cylinder space, a movable nut connected to the bolt screw, and a piston connected to one end of the movable nut, the movable nut moves along a direction of the cylinder space by the rotation of the bolt screw, and the piston has a cylindrical shape with a front surface and a rear surface open, and further includes a piston cover closing the front surface.

The movable nut may have a rotation-preventing protrusion at the one end thereof, wherein the rotation-preventing protrusion protrudes in a direction perpendicular to the moving direction of the movable nut, the piston may include a rotation-preventing groove defined therein at a location corresponding to the rotation-preventing protrusion, and the rotation-preventing protrusion may be inserted into the rotation-preventing groove.

In addition, the brake pad may include a pad connection protrusion protruding perpendicular to a surface of a back plate, the piston may include a pad connection groove at a location corresponding to the pad connection protrusion, and the pad connection protrusion may be inserted into the pad connection groove.

In addition, the rotation-preventing protrusion may include at least two rotation-preventing protrusions formed at a regular spacing along a circumferential direction of the movable nut and located outside the cylinder space, and the rotation-preventing groove may include at least two rotation-preventing grooves defined at locations respectively corresponding to the rotation-preventing protrusions.

In addition, the pad connection groove may include at least two pad connection grooves defined at a regular spacing along a circumferential direction of the piston, and the pad connection protrusion may include at least two pad connection protrusions formed at locations respectively corresponding to the pad connection grooves.

In addition, the movable nut may include a first groove defined along the circumferential direction in an outer surface of the one end thereof, the piston may include a second groove defined along the circumferential direction in an inner surface thereof, and a seal may be located in a space defined by the first groove and the second groove.

In addition, the cylinder space may include a third groove defined along an edge of an entrance thereof, the piston may include a fourth groove defined along a circumference of an outer circumferential surface thereof, and the pad pusher may further include a boot whose one end is inserted into the third groove and the other end is inserted into the fourth groove and fixed.

In addition, the piston cover may be bonded to the back plate of the brake pad by an adhesive, and the piston cover may include a heat-insulating material.

In addition, the movable nut may be prevented from rotating by the piston.

According to the embodiment of the present disclosure, the layout of the caliper body is improved, making arrangement design of the components easier.

According to the embodiment of the present disclosure, the return characteristics of the piston are improved, thereby reducing the drag phenomenon.

According to the embodiment of the present disclosure, the weight and the cost of the brake device may be reduced.

Effects to be solved in the present disclosure are not limited to the effects mentioned above, and other problems not mentioned will be clearly understood by those skilled in the art in the technical field to which the present disclosure belongs from the description below.

### BRIEF DESCRIPTION OF THE DRAWINGS

FIG. 1 is a perspective view of a brake device according to an embodiment of the present disclosure.

FIG. 2 is an exploded view of a brake device.

FIG. 3 is an exploded view of a pad pusher of a brake device.

FIG. 4 is an exploded view of a pad pusher of a brake device.

FIG. 5 shows a state in which a brake pad and a piston are connected to each other and a cross-section of the state.

FIG. 6 shows a cross-section of a piston.

FIG. 7 shows a cross-section of a portion where a brake pad and a pad pusher are connected to each other.

FIG. 8 shows a state in which a brake pad, a pad pusher, and a pad carrier are connected to each other.

### DETAILED DESCRIPTION

Advantages and features of the present disclosure, and a method for achieving the same, will become apparent with reference to the embodiments described below in detail in conjunction with the accompanying drawings. However, the present disclosure may not be limited to the embodiments disclosed below, but may be implemented in a variety of different forms. The present embodiments are provided only to ensure that the disclosure of the present disclosure is complete, and to completely inform those skilled in the art to which the present disclosure belongs, the scope of the present disclosure. The present disclosure is only defined by the scope of the claims.

The terminology used herein is for the purpose of describing the embodiments only and is not intended to limit the present disclosure. As used herein, the singular forms “a” and “an” are intended to include the plural forms as well, unless the context clearly indicates otherwise. As used herein, “comprises” and/or “comprising” do not exclude the presence or addition of one or more other components in addition to a stated component. Like reference numerals refer to like components throughout the specification, and “and/or” includes each of the mentioned components and every combination of one or more of the components. Although “first”, “second”, and the like are used to describe various components, it is apparent that such components are not limited by such terms. Such terms are only used to distinguish one component from another. Accordingly, it is apparent that the first component mentioned below may be the second component within the technical spirit of the present disclosure.

Unless otherwise defined, all terms including technical and scientific terms used herein have the same meaning as commonly understood by one of ordinary skill in the art to which the present disclosure belongs. In addition, terms defined in a commonly used dictionary are not to be interpreted ideally or excessively unless specifically defined explicitly.

Spatially relative terms “below”, “beneath”, “lower”, “above”, “upper”, and the like may be used to easily describe a correlation between one component and other components as shown in the drawings. Spatially relative terms should be understood as terms including different directions of the components during use or operation in addition to directions shown in the drawings. For example, when a component shown in the drawings is flipped, a component described as being located “below” or “beneath” another component may be placed “above” said another component. Accordingly, the exemplary term “below” may include both downward direction and upward direction. Components may also be oriented in other directions, and thus, spatially relative terms may be interpreted based on the orientation.

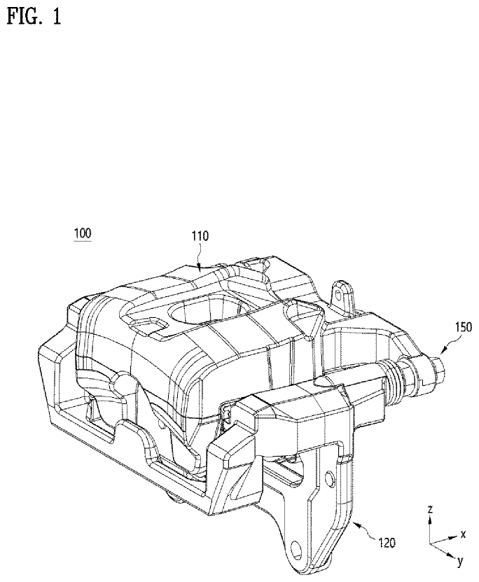

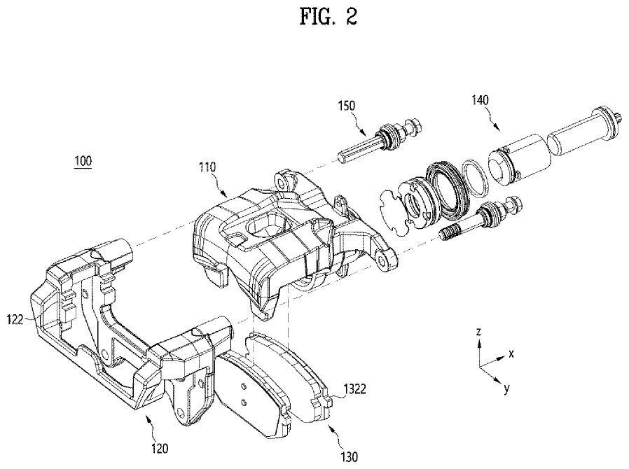

FIG. 1 is a perspective view of a brake device 100 (hereinafter, referred to as a “brake device”) according to an embodiment of the present disclosure, and FIG. 2 is an exploded view of the brake device.

Referring to FIGS. 1 and 2, the brake device 100 applies braking to a wheel by pressing a surface of a brake disc (not shown) of a vehicle with a brake pad 130. While the vehicle is traveling, the brake disc rotates with the wheel. When the brake device 100 applies a pressure to the brake disc, the brake device 100 may provide resistance to the rotation of the brake disc and reduce a rotational speed of the wheel.

The brake device 100 includes a caliper body 110 and a pad carrier 120. Additionally, the brake device 100 includes the brake pad 130, a pad pusher 140, and a connection pin 150.

The caliper body 110 is a body that may connect the components of the brake device 100 to each other. The caliper body 110 may be formed in a shape similar to a ‘⊏’ shape, so that a portion of the brake disc may be located in a concave area. The caliper body 110 may have the brake pads 130 located therein to press both surfaces of the brake disc. Additionally, the caliper body 110 may include a cylinder space in which the pad pusher 140 that pushes the brake pad 130 is seated. The cylinder space is defined as a space that may accommodate the pad pusher 140.

A material and a shape of the caliper body 110 may be determined in various ways by considering locations, loads, and the like of other components. Preferably, the material of the caliper body 110 includes a metal-based material. The caliper body 110 may be made of a metal-based material with appropriate strength to support a reaction force against a braking clamping force.

The pad carrier 120 is connected to the caliper body 110 by the connection pin 150, and is connected to both side surfaces of the brake pad 130 to guide a movement of the brake pad 130. The brake pad 130 is provided with protrusions 1322 on both side surfaces, and the pad carrier 120 is provided with grooves 122 respectively corresponding to the protrusions 1322, so that each protrusion 1322 of the brake pad 130 may be inserted into each groove 122 of the pad carrier 120.

The groove 122 of the pad carrier 120 extends along a direction in which the brake pad 130 moves to press the brake disc (e.g., a direction parallel to an x-axis in the drawing). Accordingly, the brake pad 130 may move while the protrusions 1322 on both side surfaces are guided by the pad carrier 120. The groove 122 of the pad carrier 120 extends parallel to the moving direction of the brake pad 130.

The pad carrier 120 may be connected to a fixed component such as a knuckle (not shown) of the vehicle wheel, and the caliper body 110 connected to the pad carrier 120 may move while being guided along a direction of the connection pin 150. For example, during a braking operation, the caliper body 110 may move by a reaction force exerted by the brake pad 130 on the brake disc. The direction of the connection pin 150 is parallel to a direction in which the brake pad 130 is pushed.

The pad carrier 120 may be made of a metal-based material with appropriate strength to support a braking torque acting on the brake pad 130.

The brake pad 130 may be composed of a pad 131 that is in direct contact with the brake disc and causes friction, and a back plate 132 connected to one surface of the pad. The plurality of brake pads 130 may be arranged, and a first brake pad may press one side surface of the brake disc and a second brake pad may press the other side surface of the brake disc. The pair of brake pads 130 may be arranged with the respective pad surfaces thereof facing each other with the brake disc interposed therebetween.

Although not shown in the drawing, the brake device 100 may include a motor for operating the pad pusher 140 and a gear assembly composed of gears connected to the motor. An operation of the motor is controlled based on an electrical signal. When the motor is operated, a rotational movement of the motor may be transmitted to the pad pusher 140 via the gear assembly.

The gear assembly may be an assembly of the plurality of gears to transmit the rotational movement of the motor. The plurality of gears may be connected to a motor gear, and types, the number, locations, sizes, and the like of the plurality of gears may varied with various structures designed by a person skilled in the art. The plurality of gears may be a combination of various types of gears, such as a spur gear, a helical gear, and a worm gear.

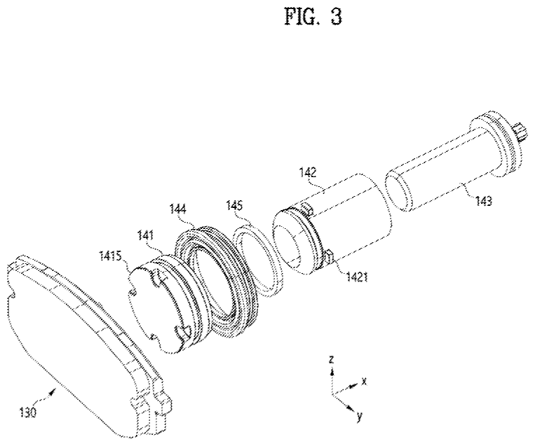

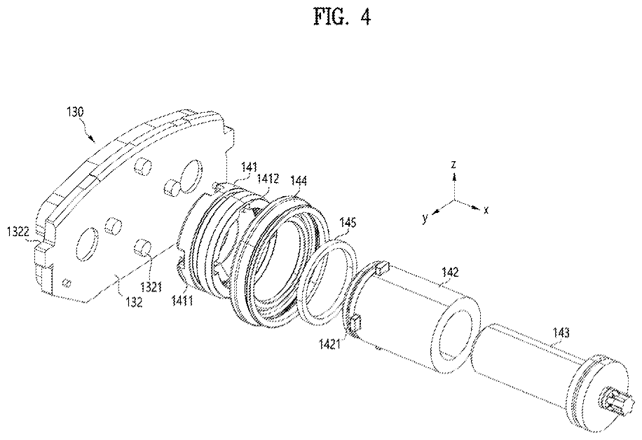

FIGS. 3 and 4 are exploded views of the pad pusher 140. The pad pusher 140 may move the brake pad 130 by receiving power from the gear assembly. Referring to FIGS. 3 and 4, the pad pusher 140 includes a piston 141, a conversion assembly 142 and 143, and/or a piston connection 146. The pad pusher 140 may also be referred to as an actuator.

The conversion assembly may refer to various components that may convert a rotational motion of the gear into a linear motion and connection schemes between the components. For example, in the present embodiment, the conversion assembly includes the bolt screw 143 and the movable nut 142 corresponding thereto. At least a portion of the conversion assembly may be seated in the cylinder space defined in the caliper body 110. The cylinder space within the caliper body 110 may be a cylindrical space in which the movable nut 142 may move.

The bolt screw 143 engages with the gear connected to the motor and rotates with respect to (or around) an axis. The bolt screw 143 may be located in a center of the cylinder space in an axial direction (e.g., in the direction parallel to the x-axis). The axial direction of the bolt screw 143 is parallel to the direction in which the brake pad 130 moves (forward or backward). The bolt screw 143 is located within the cylinder space of the caliper body 110 and rotates in place. Although not shown in the drawing, the bolt screw 143 includes a helical screw (a thread line) on an outer surface thereof.

The movable nut 142 may have a screw corresponding to the screw of the bolt screw 143, and may be connected to the bolt screw 143 and move forward or backward based on a rotation direction of the bolt screw 143. The movable nut 142 may be connected to the bolt screw 143, and may protrude out of the cylinder space or be inserted into (and located within) the cylinder space while moving. The movable nut 142 may move in a moving direction, which may correspond to or parallel to a longitudinal direction of the cylinder space.

The movable nut 142 has a length great enough such that a head thereof protrudes out of the cylinder space even when being fully inserted into the cylinder space. In other words, the length of the movable nut may be greater than a length of the cylinder space. When a bearing is located inside the cylinder space, a length L of the movable nut is greater than a length D of the cylinder space minus a thickness W of the bearing. That is, L>(D−W).

The pad pusher 140 may further include the bearing connected to the bolt screw 143. One or more bearings may be arranged, and may be located behind a tail of the movable nut 142. The bearing may include a screw bearing and may keep a location of the bolt screw 143 constant.

A portion of the movable nut 142 is located inside the cylinder space, and the movement of the movable nut 142 is guided by a direction of the cylinder space. The movable nut 142 may be referred to as a ball screw nut, and a structure of the bolt screw 143 and the movable nut 142 may be referred to as a ball screw structure.

In one example, one end of the piston 141 is connected to the brake pad 130 and the other end thereof is connected to the head of the movable nut 142 to transmit the movement of the movable nut 142 to the brake pad 130. A shape of the piston 141 includes a cylindrical shape with one surface open. The piston 141 may be connected to the head of the movable nut 142 via the open surface. That is, the head of the movable nut 142 (a portion that protrudes out of the cylinder space) is connected to the piston 141. Therefore, when the movable nut 142 moves forward or backward, the piston 141 and the brake pad 130 connected to the movable nut 142 may move forward or backward together.

Because the piston 141 is not inserted into the cylinder space, the piston 141 is located outside the cylinder space.

The head of the movable nut 142 may include a curved surface, and the piston 141 may include a corresponding curved surface on a surface thereof close to the head of the movable nut 142. For example, when the head of the movable nut 142 includes a convex curved surface, the corresponding surface of the piston 141 may include a concave curved surface. The curved surface of the movable nut 142 and the curved surface of the piston 141 may correspond to each other and may be in contact with each other.

A seal 145 is a component to block a gap created between the piston 141 and the head of the movable nut 142. The seal 145 blocks foreign substances from entering the piston 141.

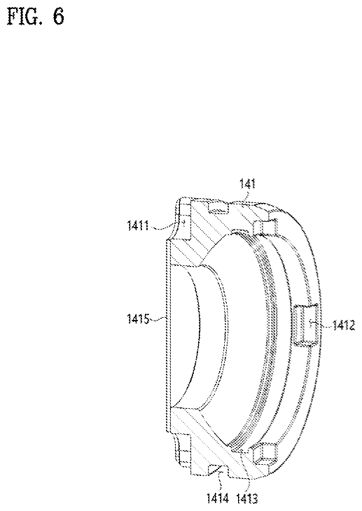

The movable nut 142 includes a first groove defined along (or extending along) a circumference of the head (one end) thereof, and the piston 141 includes a second groove 1413 (see FIG. 6) whose location corresponds to that of the first groove in an inner surface thereof. When the piston 141 and the movable nut 142 are connected to each other, the first groove and the second groove 1413 face each other, and a space where the seal 145 may be located is defined by the first groove and the second groove 1413. Therefore, the seal 145 may be located in the space created by the first groove of the movable nut 142 and the second groove 1413 of the piston 141. The seal 145 may have a shape formed along the space defined by the first groove of the movable nut 142 and the second groove 1413, and the shape of the seal 145 may include a ring shape. The shape of the seal 145 may be applied differently depending on a cross-sectional shape of the movable nut 142. Additionally, a cross-section of the seal 145 may be formed in a square or circular shape, and groove shapes of the first groove and the second groove 1413 may be changed to correspond to the cross-sectional shape of the seal 145. The seal 145 may include parts, materials, and the like commonly used for sealing.

The seal 145 blocks the gap between the movable nut 142 and the piston 141, while connecting the movable nut 142 and the piston 141 to each other so as not to be separated from each other. In this regard, the movable nut 142 and the piston 141 may be connected to each other with the predetermined gap between a surface of the head of the movable nut 142 and the inner surface of the piston 141. In the absence of an external force, the predetermined gap is defined between the curved surface of the head of the movable nut 142 and the corresponding curved surface of the piston 141. In this regard, the predetermined gap may be equal to or smaller than 2 mm.

The piston 141 may move flexibly within a range permitted by the above-mentioned predetermined gap. Therefore, an axial direction of the piston 141 may be slightly tilted differently from an axial direction of the movable nut 142.

When the pad of the brake pad 130 is worn asymmetrically, when the brake pad 130 presses the brake disc, the brake pad 130 receives an external force to tilt because of an inclination of an unevenly worn pad surface. However, in the brake device 100 according to the embodiment, because the brake pad 130 is able to be slightly tilted, an amount of an external force received by the piston 141 or the movable nut 142 is significantly reduced, and a possibility of damage is low.

Additionally, the gap between the movable nut 142 and the piston 141 may improve return performance of the brake pad 130 and prevent a collision between the movable nut 142 and the piston 141 resulted from vibration of the vehicle. Because the collision between the piston 141 and the movable nut 142 is prevented, noise of the device may be reduced and durability may be improved.

The movable nut 142 must come into contact with the piston 141 after moving forward by a distance equal to or greater than the above-mentioned arbitrary distance to transmit a pressure to the piston 141 and move the piston 141 forward. When moving backward, the movable nut 142 must move backward by the distance equal to or greater than the corresponding distance to move the piston 141 backward. When moving forward or backward, a section in which only the movable nut 142 moves without the movement of the piston 141 may be referred to as an invalid stroke section. The invalid stroke section may be set to have a size equal to or smaller than 2 mm. That is, the above-described arbitrary distance may be set to 2 mm or smaller.

Hereinafter, components related to a structure of preventing the rotation of the movable nut 142 will be described. The movable nut 142 may move in a straight line by the rotation of the bolt screw 143. In this regard, when the movable nut 142 rotates together with the rotation of the bolt screw 143, a distance that the movable nut 142 moves in the straight line changes, which may cause a problem in a movement performance of the brake pad 130. Therefore, the brake device 100 improves the movement performance of the brake pad 130 by preventing the movable nut 142 from rotating together with the bolt screw 143.

Referring to FIGS. 3 and 4, the movable nut 142 includes a rotation-preventing protrusion 1421 protruding in a direction perpendicular to the moving direction, on the head.

The rotation-preventing protrusion 1421 may include a plurality of rotation-preventing protrusions formed at a regular spacing along a circumferential direction on the head of the movable nut 142. Specifically, t least two anti-rotation protrusions 1421 may be formed at the regular spacing along the circumferential direction of the movable nut 142. Additionally, the rotation-preventing protrusion 1421 is located outside the cylinder space, and does not enter the cylinder space even when the movable nut 142 moves.

The piston 141 includes a rotation-preventing groove 1412 at a location corresponding to that of the rotation-preventing protrusion 1421. The piston 141 may include a plurality of rotation-preventing grooves 1412 at a regular spacing along a circumference of an inner circumferential surface inside a rear end. Specifically, a plurality of (i.e., at least two) rotation-preventing grooves 1412 may be defined at the regular spacing along the circumference of the inner circumferential surface. When connecting the movable nut 142 and the piston 141 to each other, the rotation-preventing protrusion 1421 is inserted into the rotation-preventing groove 1412. Because the piston 141 is not able to rotate, the movable nut 142 is not able to rotate even when receiving a force to rotate.

A cross-sectional shape of the rotation-preventing protrusion 1421 may be square or circular, and the rotation-preventing groove 1412 may be defined in a shape of a groove corresponding to the shape of the rotation-preventing protrusion 1421. As another embodiment, when connecting the piston 141 and the movable nut 142 to each other, the locations of the protrusion and the groove may be interchanged. That is, an embodiment in which the protrusion is formed on the piston and the corresponding groove is defined in the movable nut may be applied.

In one example, the piston 141 may include a plurality of pad connection grooves 1411 at a regular spacing along a circumference of an outer circumferential surface at a front end thereof. A plurality of (i.e., at least two) pad connection grooves 1411 may be defined at the regular spacing along a circumferential direction of the piston 141. In addition, the back plate 132 of the brake pad 130 includes pad connection protrusions 1321 protruding perpendicular to the surface at locations corresponding to the plurality of pad connection grooves 1411. Specifically, a plurality of (i.e., at least two) pad connection protrusions 1321 may be formed at locations corresponding to the pad connection grooves 1411. Therefore, when the brake pad 130 and the piston 141 are connected to each other, the pad connection protrusion 1321 is inserted into the pad connection groove 1411. With such structure, when the movable nut 142 receives the force to rotate, the force may be transmitted to the brake pad 130 via the piston 141. However, because the brake pad 130 is restricted in the moving direction to the straight direction and is not able to rotate, the movable nut 142 is also prevented from rotating.

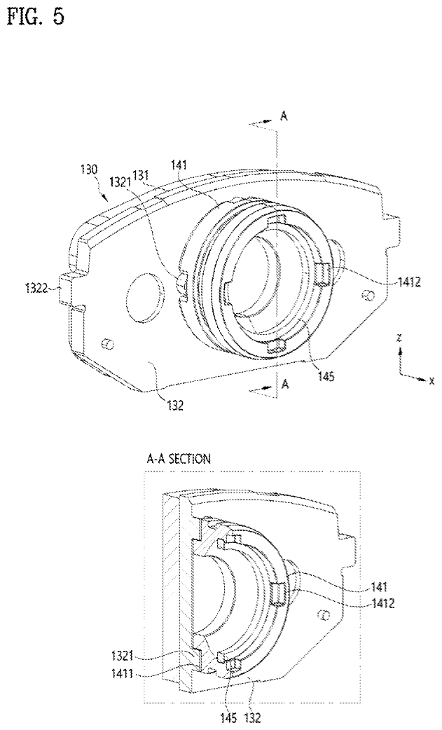

FIG. 5 shows a state in which the brake pad 130 and the piston 141 are connected to each other and a cross-section of the state. Referring to FIG. 5, the pad connection protrusion 1321 formed on the back plate 132 is inserted into the pad connection groove 1411 of the piston 141 as described above.

A cross-sectional shape of the pad connection protrusion 1321 may be square or circular, and the pad connection groove 1411 may be defined in a shape of a groove corresponding to the shape of the pad connection protrusion 1321. As another embodiment, when connecting the piston 141 and the brake pad 130 to each other, the locations of the protrusion and the groove may be interchanged. That is, an embodiment in which the protrusion is formed on the piston and the corresponding groove is defined in the brake pad may be applied.

The boot 144 blocks a space between an entrance of the cylinder space and the outer circumferential surface of the piston 141 to block the foreign substances from entering the cylinder space from the outside. The caliper body 110 includes a third groove defined along (or extending along) an edge of the entrance of the cylinder space, and the piston 141 includes a fourth groove 1414 defined along (or extending along) a circumference of the outer circumferential surface thereof. One end of the boot 144 is inserted into the third groove and fixed, and the other end of the boot 144 is inserted into the fourth groove 1414 and fixed. The boot 144 is formed with a plurality of folds, and thus, is able to be flexibly deformed even when the location of the piston 141 changes.

FIG. 6 shows a cross-section of the piston 141.

Referring to FIG. 6, the piston 141 may further include a piston cover 1415. A front surface of the piston 141 may be open, and the piston cover 1415 may be a cover that closes the open front surface of the piston 141. The piston cover 1415 may be made of a heat-insulating material to prevent high-temperature heat generated from the pad from being transferred to the piston 141 and to secure damping characteristics for noise tuning. A heat-insulating material with an appropriate heat-insulating performance, such as hard urethane, PF board, glass wool, mineral wool, and a heat reflective heat-insulating material, and the like, may be used as the heat-insulating material. The piston 141 may be connected to the brake pad 130 by applying an adhesive to the piston cover 1415 and then attaching the piston cover to the back plate 132.

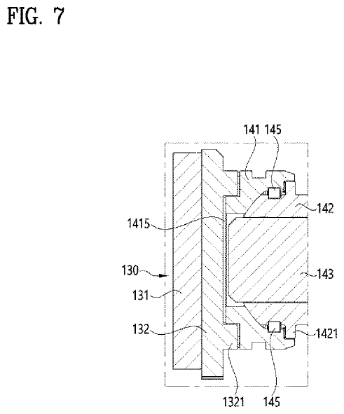

FIG. 7 shows a cross-section of a portion where the brake pad 130 and the pad pusher 140 are connected to each other.

Referring to FIG. 7, a process of moving the brake pad 130 forward is as follows. When the power of the motor rotates the bolt screw 143 via the gear assembly, the movable nut 142 moves forward. In this regard, the forward direction represents a direction in which the brake pad 130 moves to press the brake disc. When the movable nut 142 moves forward, the curved surface formed on the head of the movable nut 142 comes into contact with the inner curved surface of the piston 141 and moves the piston 141 forward. Additionally, the force transmitted to the piston 141 may be transmitted to the brake pad 130 via the piston cover 1415, allowing the brake pad 130 to move forward. The piston cover 1415 with the damping characteristics may reduce the noise generated in the process of transmitting the force.

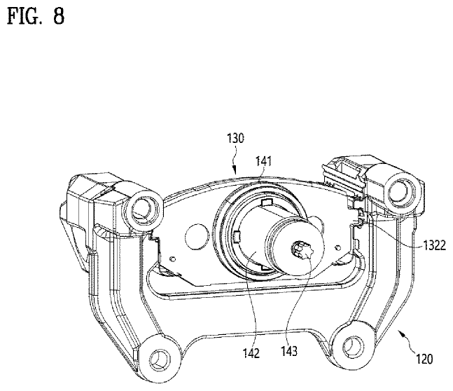

FIG. 8 shows a state in which the brake pad 130, the pad pusher 140, and the pad carrier 120 are connected to each other. Although omitted in the drawing, at least a portion of the pad pusher 140 may be inserted into the cylinder space defined in the caliper body 110.

Referring to FIG. 8, the rotation-preventing protrusion 1421 of the movable nut 142 is inserted and connected to the rotation-preventing groove 1412 of the piston 141. In addition, the piston 141 and the brake pad 130 may be connected to each other as the pad connection protrusions 1321 is inserted into the pad connection groove 1411, and both components may be adhered or bonded together by the piston cover 1415.

The protrusions 1322 protruding from both side surfaces of the brake pad 130 are guided only in the forward or backward direction by the grooves defined in the pad carrier 120. Therefore, the brake pad 130 is not allowed to rotate. Because the rotation of the brake pad 130 is restricted, the rotation of the movable nut 142 connected to the brake pad 130 is also prevented. As such, the structure to prevent the rotation of the movable nut 142 is formed outside the cylinder space of the caliper body 110. Therefore, because the rotation-preventing structure is not formed inside the cylinder space, the length of the cylinder space may be minimized. Such structure has effects of reducing a volume and a weight of the caliper body 110 and reducing the costs.

In addition, both front and rear surfaces of the piston 141 may be open, but the front surface may be closed by the piston cover 1415. A length of the piston 141 may be reduced compared to a conventional piston by opening the front surface. This is because the conventional piston had an integrated structure with a closed front surface, and required a considerable thickness of the front surface considering an ease of processing of the shape and a manufacturing scheme. The piston 141 of the brake device 100 has the open front surface, but the open front is closed by the piston cover 1415, which has the damping characteristics and is made of the heat-insulating material. Accordingly, conduction of the heat generated from the pad may be reduced, the noise damping effect may be improved, and the length of the piston 141 may be reduced, thereby reducing the volume and the weight of the brake device 100.

It is understood that the description of the various embodiments of the present disclosure is not limited only to the corresponding embodiments, and the technical ideas of the respective embodiments may also be applied to other embodiments.

As described above, the detailed description of the preferred embodiments of the present disclosure is provided such that those skilled in the art may implement and practice the present disclosure. Although the description has been made above with reference to the preferred embodiments of the present disclosure, those skilled in the art will understand that the present disclosure may be modified and changed in various ways within a range that does not deviate from the scope of the present disclosure. For example, those skilled in the art may use the respective components described in the above-described embodiments in a way of combining them to each other.

Thus, the present disclosure is not intended to be limited to the embodiments illustrated herein but is to be accorded the widest scope consistent with the principles and novel features disclosed herein.

What is claimed is:

1. A brake device comprising:
a brake pad having first and second side surfaces and a plurality of protrusions extending from the first and second side surfaces;
a pad pusher connected to the brake pad and configured to linearly move the brake pad;
a caliper body having a cylinder space, the pad pusher being seated at the cylinder space; and
a pad carrier connected to the caliper body and configured to guide the plurality of protrusions,
wherein the pad pusher includes:
a bolt screw configured to rotate with respect to an axis within the cylinder space;
a movable nut connected to the bolt screw; and
a piston connected to an end of the movable nut,
wherein the movable nut is configured to move in a moving direction corresponding to a longitudinal direction of the cylinder space when the bolt screw rotates, and
wherein the piston has a cylindrical shape and includes a front surface, a rear surface having an opening, and a piston cover covering the front surface.

2. The brake device of claim 1, wherein:
the movable nut has a rotation-preventing protrusion disposed at the end of the movable nut and extending in a direction perpendicular to the moving direction of the movable nut,
the piston includes a rotation-preventing groove disposed corresponding to the rotation-preventing protrusion, and
the rotation-preventing protrusion is located within the rotation-preventing groove.

3. The brake device of claim 2, wherein:
the brake pad includes a pad connection protrusion extending perpendicular to a surface of a back plate,
the piston includes a pad connection groove disposed corresponding to the pad connection protrusion, and
the pad connection protrusion is located within the pad connection groove.

4. The brake device of claim 3, wherein:
the rotation-preventing protrusion includes a plurality of rotation-preventing protrusions disposed outside the cylinder space at a regular spacing in a circumferential direction of the movable nut, and
the rotation-preventing groove includes a plurality of rotation-preventing grooves corresponding respectively to the plurality of rotation-preventing protrusions.

5. The brake device of claim 4, wherein:
the pad connection groove includes a plurality of connection grooves disposed at a regular spacing in a circumferential direction of the piston, and
the pad connection protrusion includes a plurality of pad connection protrusions respectively disposed corresponding to the plurality of pad connection grooves.

6. The brake device of claim 5, wherein:
the movable nut includes a first groove extending on an outer surface of the end of the movable nut in the circumferential direction of the movable unit,
the piston includes a second groove extending on an inner surface of the piston in a circumferential direction of the piston, and
a seal is disposed at a space defined by the first groove and the second groove.

7. The brake device of claim 6, wherein:
the cylinder space includes a third groove extending along an edge of an entrance of the cylinder space,
the piston includes a fourth groove extending along a circumference of an outer circumferential surface of the piston, and
the pad pusher further includes a boot having a first end located within the third groove and a second end located within the fourth groove.

8. The brake device of claim 7, wherein the piston cover is adhered to the back plate of the brake pad.

9. The brake device of claim 8, wherein the piston cover includes a heat-insulating material.

10. A brake device comprising:
a brake pad having first and second side surfaces and a plurality of protrusions extending from the first and second side surfaces;
a pad pusher connected to the brake pad and configured to linearly move the brake pad;
a caliper body having a cylinder space, the pad pusher being seated at the cylinder space; and
a pad carrier connected to the caliper body and configured to linearly guide the plurality of protrusions,
wherein the pad pusher includes:
a bolt screw configured to rotate with respect to an axis within the cylinder space;
a movable nut connected to the bolt screw; and
a piston connected to an end of the movable nut,
wherein the movable nut is configured to move in a longitudinal direction of the cylinder space by rotation of the bolt screw, and
wherein the piston is configured to prevent the rotation of the movable nut.
